(19) United States
(12) Patent Application Publication
(10) Pub. No.: US 2015/0369644 A1
(43) Pub. Date: Dec. 24, 2015

(54) Thermally-Dissipative Flow Sensor System

(71) Applicant: Hayward Industries, Inc., Elizabeth, NJ (US)

(72) Inventor: John A. Powning, Providence, RI (US)

(73) Assignee: Hayward Industries, Inc., Elizabeth, NJ (US)

(21) Appl. No.: 14/600,515

(22) Filed: Jan. 20, 2015

Related U.S. Application Data
(60) Provisional application No. 62/014,475, filed on Jun. 19, 2014.

(51) Int. Cl. G01F 1/698; G01F 1/69

(52) U.S. Cl. CPC G01F 1/698; G01F 1/69

(57) ABSTRACT

Exemplary embodiments of the present disclosure are generally directed to a thermally-dissipative flow monitoring system. In exemplary embodiments, a solid state flow sensor system heats a first thermistor (“flow thermistor”) to a heat to” temperature and allows the first thermistor to cool to a “cool to” temperature. The flow sensor system measures the time it takes the first thermistor to reach a “heat to” temperature and/or a “cool to” temperature. These times can be used to determine if the flow rate is above or below a particular threshold (e.g., as in the case of a flow switch), or to determine the flow rate (e.g., as in the case of a flow sensor). The “heat to” temperature and “cool to” temperatures are set using a second thermistor (“fluid thermistor”) which is measures the surrounding fluid temperature.

### CROSS-REFERENCE TO RELATED APPLICATIONS

The present application claims the benefit of priority to U.S. Provisional Patent Application No. 62/014,475, filed Jun. 19, 2014, the entire contents of which are incorporated herein by reference for all purposes.

### BACKGROUND

Flow sensors are typically implemented to measure flow rate of a fluid through a conduit or pipe. There are primarily two types of flow sensors that have been implemented: mechanical and solid-state sensors.

Mechanical flow sensors can measure flow rate of a fluid based on the movement of a paddle or paddle wheel. For example, the speed at which a paddle wheel rotates in response to a fluid flow can be proportional to the flow rate of the fluid. Mechanical flow sensors (e.g., paddle or paddle-wheel type sensors) can be expensive and susceptible to mechanical “wear out,” dirt, and debris. In addition, mechanical flow sensors may have unpredictable responses to turbulent flows.

Solid state flow sensors typically include no moving parts and tend to exhibit longer operational life than mechanical flow sensors. One type of solid-state flow sensor is a thermal-dissipative flow sensor. This type of sensor can measure flow rates independent of the direction with which fluid flows, and therefore, may provide a more predictable response to turbulent flow than mechanical flow sensors. However, existing thermally-dissipative flow sensors often operate with a thermistor that is heated to a constant temperature. Such operation of a thermistor at a constant heated temperature in a thermally-dissipative flow sensor can be problematic for several reasons. As one example, heating and maintaining a thermistor at a constant temperature can expose the thermistor to undesirable thermal stress, which can reduce the operational life of the thermistor. As another example, wasted energy in the form of heat dissipated by the thermistor can be generated when the thermistor is not being used to measure the flow rate of fluid. As yet another example, heating and maintaining a thermistor at a constant temperature can result in a start-up condition for the flow sensor that requires a long time to settle.

### SUMMARY

Exemplary embodiments of the present disclosure are generally directed to a thermally-dissipative flow monitoring system. In exemplary embodiments, a solid state flow sensor system heats a first thermistor (“flow thermistor”) to a “heat to” temperature and allows the first thermistor to cool to a “cool to” temperature. The flow sensor system measures the time it takes the first thermistor to reach a “heat to” temperature and/or a “cool to” temperature. These times can be used to determine if the flow rate is above or below a particular threshold (e.g., as in the case of a flow switch), or to determine the flow rate (e.g., as in the case of a flow sensor).

In accordance with embodiments of the present disclosure, a system for measuring a flow rate of a fluid is disclosed. The system includes a water thermistor disposed in a fluid, a flow thermistor disposed in the fluid, flow measurement circuitry, and a processing device. The flow measurement circuitry is operatively coupled to the water thermistor and the flow thermistor. The processing device is operatively coupled to the flow measurement circuitry and is programmed to control the flow measurement circuitry to periodically increase a temperature of the flow thermistor to a first temperature and allow the temperature of the flow thermistor to decrease to a fluid temperature. The processing device is programmed to determine a flow rate based on an amount of time that elapses between the flow thermistor having the first temperature and the flow thermistor having a second temperature that is set based the water thermistor.

In accordance with embodiments of the present disclosure, the processing device of the system can be programmed to output a control signal to the flow measurement circuitry for a programmed period of time after which the processing device ceases outputting the control signal after the programmed period of time elapses. The flow measurement circuitry can increase the temperature of the flow thermistor in response to the control signal and can continue to increasing the temperature of the flow thermistor after the programmed period of time elapses. The flow measurement circuitry can be configured to continue increasing the temperature of the flow thermistor until the temperature of the flow thermistor reaches the first temperature.

In accordance with embodiments of the present disclosure, the flow measurement circuitry of the system can include a first switching circuit having a first electronic switch operatively coupled to the processing device and the flow thermistor, wherein the processing device controls the first electronic switch to periodically increase the temperature of the flow thermistor. The first switching circuit can also include a second electronic switch operatively coupled to the processing device and the flow thermistor, wherein the processing device controls the second electronic switch to periodically sample the temperature of the flow thermistor.

In accordance with embodiments of the present disclosure, the flow measurement circuitry can include a second switching circuit having a first electronic switch operatively coupled to the processing device and the water thermistor, wherein the processing device controls the first electronic switch to output a first voltage from the second switching circuit that corresponding to the first temperature (e.g., a heat-to temperature). The second switching circuit can include a second electronic switch operatively coupled to the processing device and the water thermistor, wherein the processing device controls the second electronic switch to output a second voltage corresponding to the second temperature (e.g., a cool-to temperature).

In accordance with embodiments of the present disclosure, the first temperature is set based on the water thermistor and the flow measurement circuitry can include a comparator configured to compare a voltage based on a resistance of the flow thermistor to a voltage based on a resistance of the water thermistor, wherein the flow measurement circuitry stops increasing the temperature of the flow thermistor when the voltage based on a resistance of the flow thermistor is greater than or equal to the voltage based on a resistance of the water thermistor.

In accordance with embodiments of the present disclosure, the flow measurement circuitry can include a comparator configured to compare a voltage based on a resistance of the flow thermistor to a voltage based on a resistance of the water thermistor and to output a control signal when the voltage based on a resistance of the flow thermistor is less than or equal to the voltage based on a resistance of the water thermistor, the control signal indicating that the flow thermistor has reached the second temperature.

In accordance with embodiments of the present disclosure, a method of measuring a flow rate of a fluid is disclosed. The method includes controlling a flow measurement circuit to increase a temperature of a flow thermistor in response to a first control signal and comparing a voltage based on a resistance of the flow thermistor to a voltage based on a resistance of the fluid thermistor to determine whether the flow thermistor is greater than or equal to a first temperature. The flow thermistor and the fluid thermistor can be disposed in a fluid, such as water. The method also includes controlling the flow measurement circuit to stop increasing the temperature of the flow thermistor when the voltage based on a resistance of the flow thermistor is greater than or equal to the voltage based on a resistance of the fluid thermistor and comparing a voltage based on a resistance of the flow thermistor to a voltage based on a resistance of the fluid thermistor to determine whether the flow thermistor is less than or equal to a second temperature. The method further includes controlling the flow measurement circuit to output a second control signal when the voltage based on a resistance of the flow thermistor is less than or equal to the voltage based on a resistance of the fluid thermistor to indicate that the flow thermistor reached the second temperature, determining a flow rate of based on a time that elapses between the flow thermistor reaching the first and second temperatures, and allowing the temperature of the flow thermistor to continue decreasing towards a fluid temperature.

In accordance with embodiments of the present disclosure, the first control signal of the method is output by a processing device operatively coupled to the flow measurement circuitry and the first control signal is output for a programmed period of time after which the first control signal ceases to be output from the processing device. The temperature of the flow thermistor can continue to be increased by the flow measurement circuitry after the first control signal ceases to be output by the processing device.

In accordance with embodiments of the present disclosure, the method can further include sampling a first output voltage periodically from the flow measurement circuitry by the processing device. The first output voltage can correspond to a temperature of the flow thermistor.

In accordance with embodiments of the present disclosure, the method can further include sampling a second output voltage from the flow measurement circuitry by the processing device when the flow thermistor reaches the first temperature. The second output voltage can correspond to a temperature of the fluid thermistor.

In accordance with embodiments of the present disclosure, the method can further include sampling a second output voltage from the flow measurement circuitry by the processing device when the flow thermistor reaches the second temperature.

In accordance with embodiments of the present disclosure, the first temperature in the method can be a first specified number of degrees above the fluid temperature and the second temperature can be a second specified number of degrees above the fluid temperature. The first specified number of degrees can be greater than the second specified number of degrees.

In accordance with embodiments of the present disclosure, the method can further include controlling a flow measurement circuit to increase a temperature of a flow thermistor in response to a first control signal again after allowing the temperature of the flow thermistor to decrease a fluid temperature.

In accordance with embodiments of the present disclosure, a thermally dissipative flow rate sensor is disclosed that includes a first switching circuit and a second switching circuit. The first switching circuit is operatively coupled to a flow thermistor and is configured to switch between a thermistor heating mode to heat the flow thermistor and a thermistor cooling mode to cool the flow thermistor. The second switching circuit is operatively coupled to a water thermistor and is configured to switch between outputting a first output voltage from the second switching circuit corresponding to a first temperature to which the flow thermistor is to be heated and outputting a second output voltage from the second switching circuit corresponding to a second temperature to which the flow thermistor is to be cooled.

In accordance with embodiments of the present disclosure, the first switching circuit includes a first electronic switch operative coupled to the flow thermistor, and a second electronic switch operative coupled to the flow thermistor in parallel with the first electronic switch. The first electronic switch is operable to heat the flow thermistor and the second electronic switch is operable to output a sample voltage corresponding to a temperature of the flow thermistor. Each of the first and second electronic switches can have a conductive state and a non-conductive state. The first electronic switch can be operable to heat the flow thermistor when the first electronic switch is in the conductive state and cease heating the flow thermistor when the first electronic switch is in the non-conductive state. The second electronic switch can be operable to output the sample voltage when the second electronic switch is in the conductive state and to cease outputting the sample voltage when the second electronic switch is in the non-conductive state.

In accordance with embodiments of the present disclosure, the thermally dissipative flow rate sensor can include a comparator having a first input terminal that is operatively coupled to the flow thermistor, a second input terminal that is operatively coupled to the water thermistor, and an output terminal that is operatively coupled to the first switch. The comparator can receive a flow thermistor voltage associated with temperature of the flow thermistor at the first input terminal and the first output voltage from the second switching circuit at the second terminal, and can output a control signal to the first electronic switch from the output terminal in response to a comparison of the flow thermistor voltage and the first output voltage. The first electronic switch can transition from the conductive state to the non-conductive state in response to the control signal output by the comparator when the flow thermistor voltage associated with temperature of the flow thermistor is greater than the first output voltage.

In accordance with embodiments of the present disclosure, the thermally dissipative flow rate sensor can include a comparator having a first input terminal that is operatively coupled to the flow thermistor, a second input terminal that is operatively coupled to the water thermistor, and an output terminal configured to output a control signal in response to a comparison of a flow thermistor voltage associated with temperature of the flow thermistor received by the first input terminal and the second output voltage from the second switching circuit received by the second terminal. The control signal output by the comparator can indicate that the flow thermistor has reached the second temperature when the flow thermistor voltage associated with temperature of the flow thermistor is less than the second output voltage.

In accordance with embodiments of the present disclosure, the second switching circuit of the thermally dissipative flow rate sensor can include a first electronic switch operatively coupled to the water thermistor and a second electronic switch operative coupled to the flow thermistor in parallel with the first electronic switch. The first electronic switch can be operable to output the first output voltage and the second electronic switch can be operable to output the second output voltage. Each of the first and second electronic switches have a conductive state and a non-conductive state. The first electronic switch can be operable to output the first output voltage from the second switching circuit when the first electronic switch is in the conductive state and to cease outputting the first output voltage from the second switching circuit when the first electronic switch is in the non-conductive state. The second electronic switch can be operable to output the second output voltage from the second switching circuit when the second electronic switch is in the conductive state and to cease outputting the second output voltage from the second switching circuit when the second electronic switch is in the non-conductive state.

Any combination and permutation of embodiments is envisioned. Other objects and features will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

FIGS. 1A and 1B depict exemplary flow monitoring systems to determine a flow rate of fluid in accordance with exemplary embodiments of the present disclosure.

FIG. 2 depicts an exemplary embodiment of flow measurement circuitry that can be implemented in accordance with exemplary embodiments of the present disclosure.

FIG. 3 is a flowchart of a process for determining flow rate of a fluid in accordance with exemplary embodiments of the present disclosure.

FIG. 4 is a graph that shows exemplary control and sensed signals that can be utilized by exemplary embodiments of the present disclosure.

FIG. 5 is a graph illustrating an effect of a changing water temperature on flow measurements.

FIG. 6 depicts a thermistor in accordance with exemplary embodiments of the present disclosure.

FIG. 7 shows an exemplary implementation of a flow sensor system in a swimming pool/spa environment in accordance with exemplary embodiments of the present disclosure.

### DESCRIPTION OF EXEMPLARY EMBODIMENTS

Exemplary embodiments of the present disclosure are generally directed to a thermally-dissipative flow monitoring system. In exemplary embodiments, a solid state flow sensor system heats a first thermistor (“flow thermistor”) to a “heat to” temperature and allows the first thermistor to cool to a “cool to” temperature. The flow sensor system measures the time it takes the first thermistor to reach a “heat to” temperature and/or a “cool to” temperature. These times can be used to determine if the flow rate is above or below a particular threshold or to determine an actual value of the flow rate. The “heat to” temperature and “cool to” temperatures are set using a second thermistor (“water thermistor”) which is measuring the surrounding water temperature.

As used herein, the term “flow sensor” is used to refer to a device, system, or apparatus that is configured to determine if the flow rate is greater than, less than, and/or or equal to a particular threshold value, to determine no-flow conditions, and/or to determine an actual value of a flow rate.

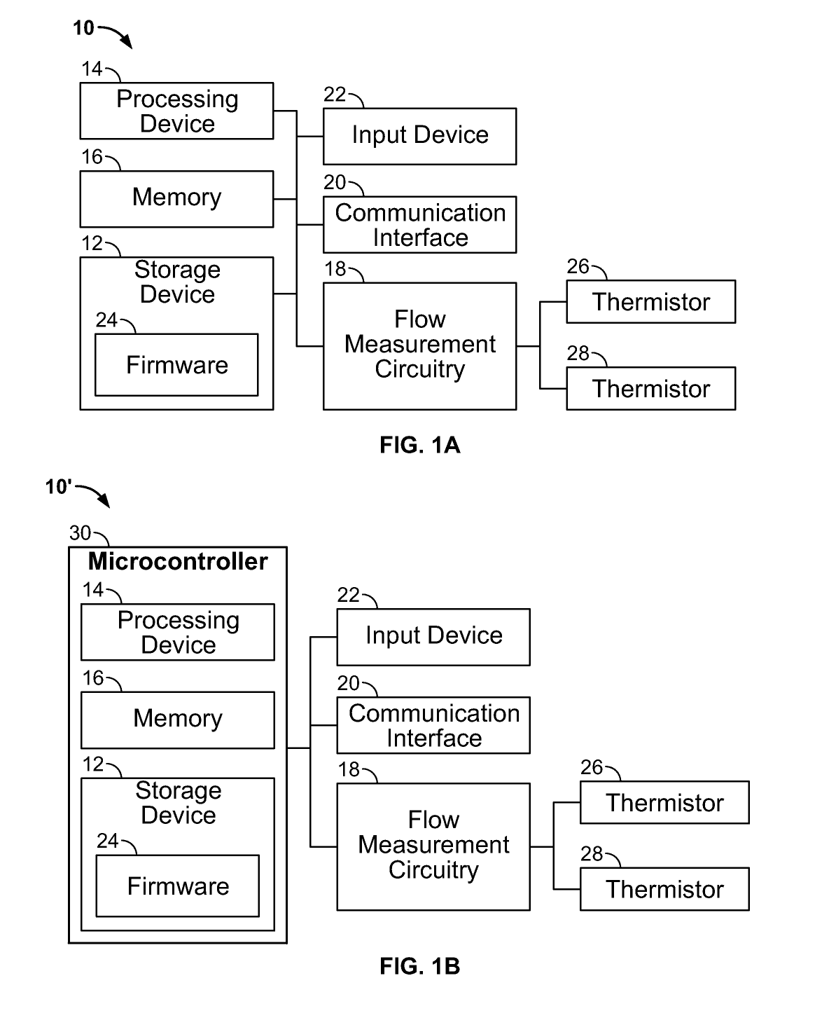

FIG. 1A is a diagram showing hardware and software components of an exemplary flow monitoring system 10 implementing a solid state thermally dissipative flow sensor for determining a flow rate of fluid (e.g., flowing through a conduit or pipe) in accordance with exemplary embodiments of the present disclosure. Exemplary fluids for which flow can be monitored include, for example, water, wastewater, and/or chemicals, such as water, wastewater, and/or chemicals that flow through pipes. As one example, exemplary embodiments of the present disclosure can be implemented for pool, spa, and/or aquaculture applications to monitor the flow of water and/or chemicals flowing through pipes/conduits. Exemplary embodiments of the system 10 can be implemented as a stand-alone system and/or can be a subsystem incorporated into another system. For example, the system 10 can be incorporated into a chlorinator, water heater, and/or other swimming pool, spa, and/or aquaculture systems including, for example, a swimming pool, spa, and/or aquaculture control systems.

The system 10 includes a storage device 12, a processing device 14 (e.g., a microprocessor), random access memory (RAM) 16, and flow measurement circuitry 18. In some embodiments, the system 10 can include a communications interface 20 (e.g., a network interface, a serial interface, a parallel interface, etc.) to facilitate communication between the system 10 and other systems or devices. In some embodiments, the storage device 12, processing device 14, and RAM 16 can be components of a microcontroller. One or more input devices 22 can be in communication with the system 10 to allow an operator of the system 10 to interact with the system 10. In some embodiments, the system 10 can also interface with a display device, e.g., a liquid crystal display (LCD), and/or can output data/information associated with the flow of fluid to another device or system for further processing. The storage device 12 can include any suitable, non-transitory computer-readable storage medium, e.g., a disk, non-volatile memory, read-only memory (ROM), erasable programmable ROM (EPROM), electrically-erasable programmable ROM (EEPROM), flash memory, and the like.

In exemplary embodiments, firmware 24 can be embodied as computer-readable/executable program code stored on the non-transitory computer-readable storage device 12 and can be executed by the processing device 14 using any suitable, high or low level computing language and/or platform, such as, e.g., Java, C, C++, C#, assembly language code, machine language code, and the like. Execution of the computer-readable code of the firmware 24 by the processing device 14 can cause the processing device 14 to implement one or more processes for determining and/or measuring the flow rate of fluid. For example, in exemplary embodiments, the firmware 24 can be programmed and/or configured to perform exemplary processes described herein.

The processing device 14 can retrieve data from, and store data to, the storage device 12 and/or the RAM 16. For example, the firmware 24 may be stored on the storage device 12 and/or a RAM 16. In some embodiments, the executable code for implementing the firmware 24 can be retrieved from the storage device 12 and copied to RAM 16 during and/or upon implementation of the processes described herein. Data/information such as thermistor temperatures, water temperatures, heating time periods, cooling time periods, flow rates, and/or any other suitable data/information can be determined, utilized, generated, and/or stored by the system 10 upon execution of the firmware 24.

The flow measurement circuitry 18 can be operatively coupled to the processing device 14 and thermistors 26 and 28. The circuitry 18 can be configured to interact with the thermistors 26 and 28 in response to signals received from the processing device 14 by the circuitry 18 and/or can be configured to output one or more signals to the processing device 14, which can be used by the processing device 14 to determine one or more characteristics of the thermistors 26 and 28 (e.g., thermistor temperature, thermistor resistance) and/or to determine one or more characteristics of the environment within which the thermistors 26 and 28 are disposed (e.g., fluid temperature, flow rate).

In some embodiments, the flow measurement circuitry 18 can be configured to control a temperature of the thermistors 26 and/or 28. For example, in an exemplary embodiment, the flow measurement circuitry 18, in response to one or more control signals from the processing device 14, can control an electrical current flowing through the thermistor 28 to heat the thermistor 28 to a specified “heat to” temperature, at which time the electric current can be reduced and/or eliminated based on control signals received by the circuitry 18 from the processing device 14 to allow the thermistor 28 to cool. The time it takes for the temperature of the thermistor 28 to cool to a specified “cool to” temperature can be used by the processing device 14 to determine a flow rate of fluid passed the thermistor. The processing device can allow the thermistor 28 to continue to cool towards the fluid temperature after the flow rate is determined so that the temperature of thermistor decrease to less than the “cool to” temperature between flow rate measurements.

In some embodiments, the flow measurement circuitry 18 can measure an electrical characteristic from the thermistors 26 and/or 28, which can correspond to a physical characteristic of the thermistors, and/or can measure a physical characteristic of the environment within which the thermistors 26 and/or 28 are disposed. As one example, in an exemplary embodiment, the flow measurement circuitry 18, in response to one or more control signals from the processing device 14, can determine a resistance of the thermistors 26 and/or 28, and the resistance can be used to determine a temperature of the thermistors 26 and/or 28.

FIG. 1B is a diagram showing hardware and software components of another exemplary flow monitoring system 10′ implementing a solid state thermally dissipative flow sensor for determining a flow rate of fluid (e.g., flowing through a conduit or pipe) in accordance with exemplary embodiments of the present disclosure. Exemplary embodiments of the system 10′ can be implemented as a stand-alone system and/or can be a subsystem incorporated into another system. For example, the system 10′ can be incorporated into a chlorinator, water heater, and/or other swimming pool or spa system including, for example, a swimming pool control system. An exemplary implementation of the system 10′ in a swimming pool environment is shown FIG. 8. The system 10′ can include a microcontroller 30 that includes the storage device 12, processing device 14, and RAM 16. The microcontroller 30 can be operatively coupled with the flow measurement circuitry 18 (and the thermistors 26 and 28), the communication interface 20, and the input device 22. An operation of the system 10′ can be substantially similar to the operation of the system 10, except that the storage device 12, the processing device 14, and the RAM 16 are packaged to form a microcontroller 30.

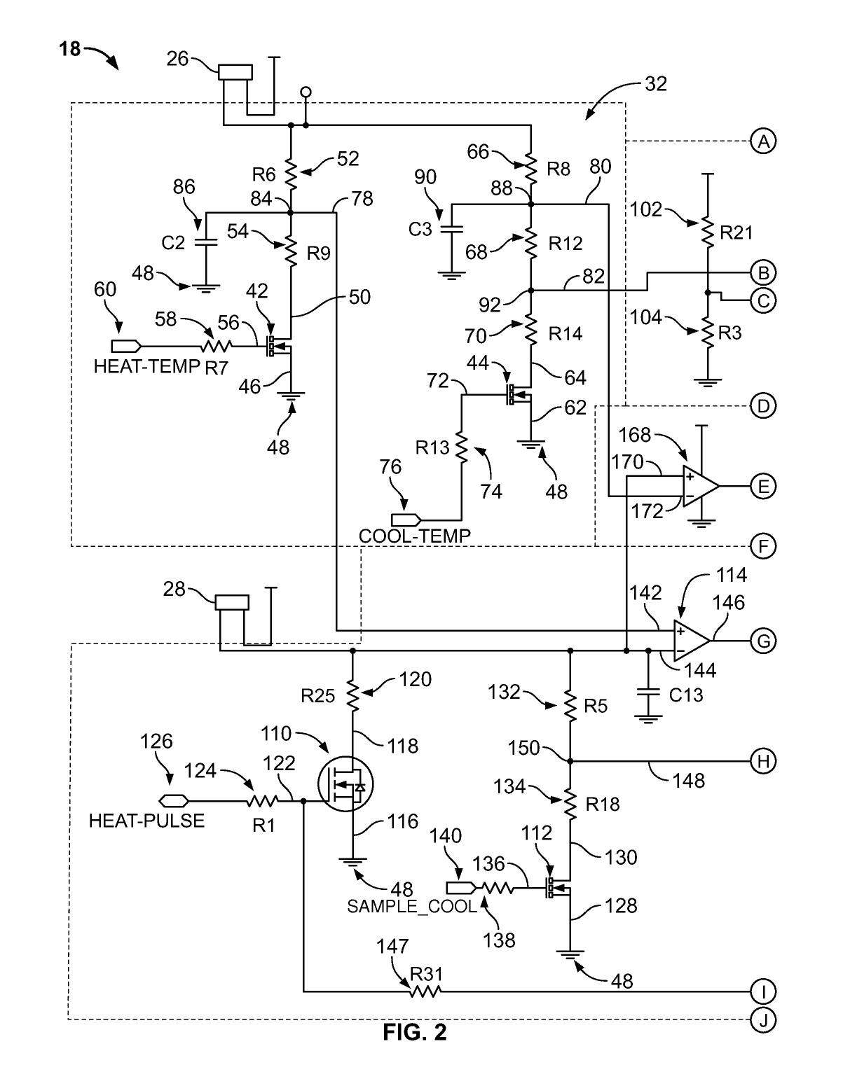

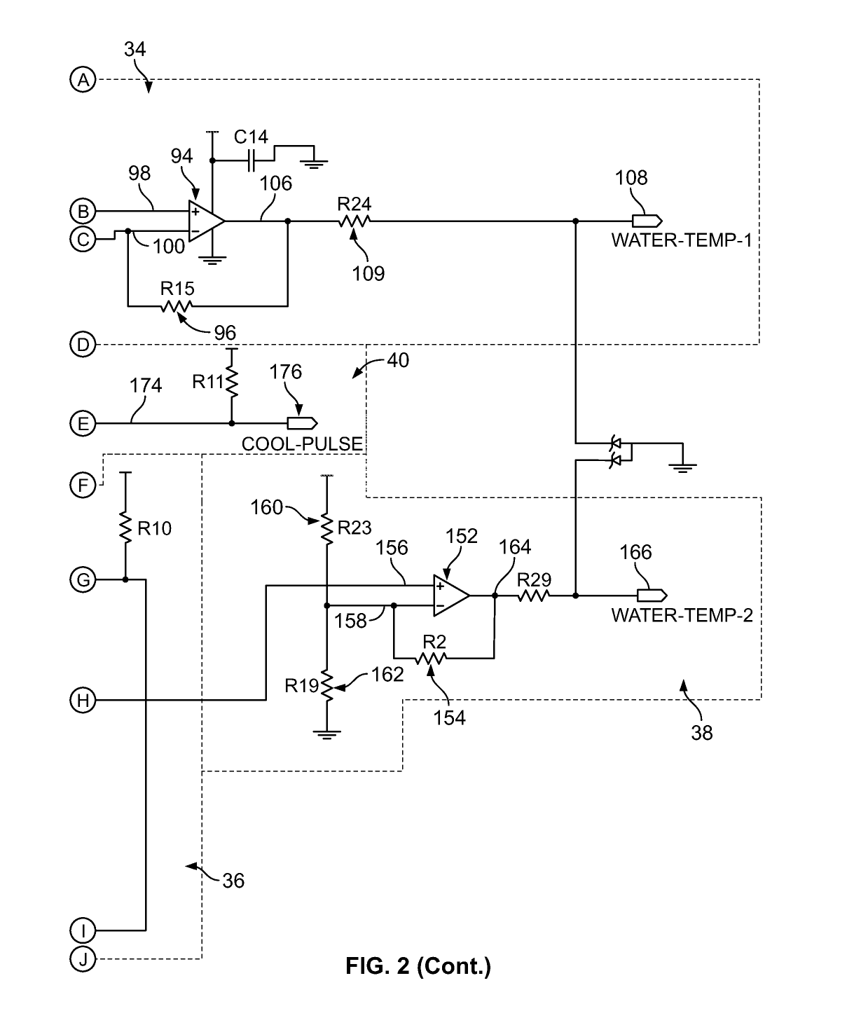

FIG. 2 depicts an exemplary embodiment of the flow measurement circuitry 18 in accordance with the present disclosure. The flow measurement circuitry 18 can include a switching circuit 32, a first water temperature output stage 34, a switching circuit 36, a second water temperature output stage 38, and an output stage 40.

The switching circuit 32 can interface with the thermistor 26 that can be used by the circuitry 18 to control one or more outputs of the switching circuit 32. As an example, the switching circuit 32 can interface with the thermistor 26 to output a voltage that corresponds to a temperature of the fluid within which the thermistor 26 is disposed, output a “heat to” temperature to specify a temperature to which the thermistor 28 is to be heated, and/or output a “cool to” temperature to specify a temperature to which the thermistor 28 is to be cooled to facilitate measurement of a flow rate of fluid. The switching circuit 32 can include electronic switches having a conductive state and a non-conductive state. In the present embodiment, the switches can be formed by transistors 42 and 44 (e.g., field effect transistors). As shown in FIG. 2, a source 46 of the transistor 42 can be connected to ground 48, a drain 50 of the transistor 42 can be operatively connected to the thermistor 26 via resistors 52 and 54, and a gate 56 of the transistor 42 can be operatively coupled to an output of the processing device via a resistor 58. In exemplary embodiments, the processing device can output a control signal “HEAT_TEMP” as an input 60 to the gate 56 of the transistor 42 to turn “on” the transistor 42 (i.e. operate the transistor 42 in the conductive state) and turn “off” the transistor 42 (i.e. operate the transistor 42 in the non-conductive state). A source 62 of the transistor 44 can be connected to the ground 48, a drain 64 of the transistor 44 can be operatively connected to the thermistor 26 via resistors 66, 68, and 70, and a gate 72 of the transistor 44 can be operatively coupled to an output of the processing device via a resistor 74. In exemplary embodiments, the processing device can output a control signal “COOL_TEMP” to an input 76 of the gate 72 of the transistor 44 to turn “on” the transistor 44 (i.e. operate the transistor 44 in the conductive state) and turn “off” the transistor 44 (i.e. operate the transistor 44 in the non-conductive state).

The switching circuit 32 can include outputs 78, 80, and 82. The output 78 corresponds to a node 84 between the resistors 52 and 54 and provides an input to the switching circuit 36. A capacitor 86 can be coupled to the node 84 and ground 48 to reduce and/or control electrical noise at the node 84. The output 78 can determined based on the operation of the transistor 42, a resistance of the thermistor 26, a resistance of the resistor 52, and a resistance of the resistor 54, as well as a voltage applied to the thermistor 26 (e.g., fifteen volts). As one example, if the transistor 42 is turned “on”, the output 78 is determined by the voltage divider formed about the node 84 by the thermistor 26, the resistor 52, and the resistor 54. When the transistor 42 is turned “on” the output 78 can output a voltage that corresponds to a “heat to” temperature that the thermistor 28 is heated to via the switching circuit 36. In exemplary embodiments, the “heat to” temperature is a specified temperature above the fluid temperature. As another example, if the transistor 42 is turned “off”, the output 78 is generally determined by the thermistor 26, the resistor 52, and an input impedance of switching circuit 36 to which the node 84 is operatively connected. In exemplary embodiments, the input impedance of the switching circuit 36 with respect to the output 78 is a high impedance (e.g., one mega-ohm) such that the output 78 is generally equal to the voltage applied to the thermistor 26 (e.g., fifteen volts).

The output 80 corresponds to a node 88 between the resistors 66 and 68 and provides an input to the “cool to” temperature stage 38. A capacitor 90 can be coupled to the node 88 and ground 48 to reduce and/or control electrical noise at the node 88. The output 80 can determined based on the operation of the transistor 44, a resistance of the thermistor 26, a resistance of the resistor 66, a resistance of the resistor 68, and a resistance of the resistor 70, as well as a voltage applied to the thermistor 26 (e.g., fifteen volts). As one example, if the transistor 44 is turned “on”, the output 80 is determined be the voltage divider formed about the node 88 by the thermistor 26, the resistor 66, the resistor 68, the resistor 70, and the capacitor 90. When the transistor 44 is turned “on” the output 80 can output a voltage that corresponds to a “cool to” temperature that the thermistor 28 is compared to via the comparator 168 of the output stage 40. In exemplary embodiments, the “cool to” temperature is a specified temperature above the fluid temperature. As another example, if the transistor 44 is turned “off”, the output 252 is generally determined by the thermistor 26, the resistor 66, and an input impedance of the output stage 40 to which the node 88 is operatively connected. In exemplary embodiments, the input impedance of the output stage 40 with respect to the output 252 is a high impedance (e.g., one mega-ohm) such that the output 252 is generally equal to the voltage applied to the thermistor 26 (e.g., fifteen volts).

The output 82 corresponds to a node 92 between the resistors 68 and 70 and provides an input to the water temperature output stage 34. The output 82 can be determined based on the operation of the transistor 44, a resistance of the thermistor 26, a resistance of the resistor 66, a resistance of the resistor 68, and a resistance of the resistor 70, as well as a voltage applied to the thermistor 26 (e.g., fifteen volts). As one example, if the transistor 44 is turned “on”, the output 82 is determined by the voltage divider formed about the node 92 by the thermistor 26, the resistor 66, the resistor 68, and the resistor 70. When the transistor 44 is turned “on”, the output 82 can output a voltage that corresponds to a temperature of the thermistor 26 and/or the environment within which the thermistor 26 resides (e.g., a water temperature). As another example, if the transistor 44 is turned “off”, the output 82 is generally determined by the thermistor 26, the resistors 66 and 68, and an input impedance of water temperature output stage 34 to which the node 92 is operatively connected. In exemplary embodiments, the input impedance of the output stage 40 with respect to the output 258 is a high impedance (e.g., one mega-ohm) such that the output 258 is generally equal to the voltage applied to the thermistor 26 (e.g., fifteen volts).

The water temperature output stage 34 can include a non-inverting amplifier formed by an operational amplifier 94 and a negative feedback resistor 96. A positive terminal 98 of the operational amplifier 94 receives the output 82 of the switching circuit 32 as an input and an input to a negative terminal 100 of the operational amplifier 94 is determined by a voltage divider formed by resistors 102 and 104 and the negative feedback resistor 96. An output 106 of the operational amplifier 94 is operatively coupled to a “WATER_TEMP_1” node 108 of the processing device via a resistor 109. The water temperature output stage 34 can operate to output a voltage to the processing device that corresponds to a temperature of the thermistor 26, which in exemplary embodiments can correspond to a temperature of water within which the thermistor 26 is disposed.

The switching circuit 36 can interface with the thermistor 28 that can be used by the circuitry 18 to control one or more outputs of the switching circuit 36. The switching circuit 36 can include electronic switches having a conductive and a non-conductive state. In the present embodiment, the switches can be formed by transistors 110 and 112 (e.g., field effect transistors), and can include a comparator 114. As shown in FIG. 2, a source 116 of the transistor 110 can be connected to the ground 48, a drain 118 of the transistor 110 can be operatively connected to the thermistor 28 via a resistor 120, and a gate 122 of the transistor 110 can be operatively coupled to an output of the processing device via a resistor 124. In exemplary embodiments, the processing device 14 can output a control signal “HEAT_PULSE” as an input 126 to the gate 122 of the transistor 110 to turn “on” the transistor 110 (i.e. operate the transistor 110 in the conductive state). The control signal “HEAT_PULSE” can last for a programmed period of time. When the transistor 110 is turned “on”, electrical current can be drawn through thermistor 28 and the resistor 120, which cause the temperature of the thermistor to increase. As the temperature of the thermistor 28 increases, the resistance of the thermistor 28 decreases, which causes the temperature of the thermistor to continue increasing. When the control signal “HEAT_PULSE terminates, the output of the comparator 114 can continue to drive the gate 122 high to facilitate continued heating of the thermistor 28 until a heat-to temperature for the thermistor 28 is reached, at which time the output of the comparator 114 can drive the gate 122 low to turn “off” the transistor 110. When the transistor 110 is turned “off”, electrical current does not flow through the resistor 120, and therefore, electrical current is not drawn through the thermistor 28 by the transistor 110; thereby allowing the thermistor 28 to being cooling.

With reference to the transistor 112, a source 128 of the transistor 112 can be connected to the ground 48, a drain 130 of the transistor 44 can be operatively connected to the thermistor 28 via resistors 132 and 134, and a gate 136 of the transistor 112 can be operatively coupled to an output of the processing device via a resistor 138. In exemplary embodiments, the processing device can output a control signal “SAMPLE_COOL”, as described herein, to an input 140 of the gate 136 of the transistor 112 to turn “on” the transistor 112 (i.e. operate the transistor 112 in the conductive state) and turn “off” the transistor 112 (i.e. operate the transistor 112 in the non-conductive state).

The comparator 114 can include a positive terminal 142, a negative terminal 144, and an output 146. The positive terminal 142 and negative terminal 144 can have high input impedance (e.g., one mega ohm). As shown in FIG. 2, the positive terminal 142 of the comparator 114 can receive, as an input, the output 78 from the switching circuit 32 and the negative terminal 144 of the comparator 114 can receive, as an input, a voltage that is determined by an operation of the thermistor 28, the transistor 110, and the transistor 112. The output 146 of the comparator 114 can be operatively connected to the gate 122 of the transistor 110 via a resistor 147.

The switching circuit 36 can include an output 148 that forms an input to the second water temperature stage 38. The output 148 corresponds to a voltage at a node 150 between the resistors 132 and 134. The output 148 can be determined based on the operation of the transistor 112, a resistance of the thermistor 28, a resistance of the resistor 132, and a resistance of the resistor 134, as well as a voltage applied to the thermistor 28 (e.g., fifteen volts). For example, when the transistor 112 is turned “on”, the switching circuit 36 is configured to output a voltage (e.g., via the output 148) that relates to the resistance of the thermistor 28. The voltage at the output 148 is determined by the voltage divider formed about the node 150 by the thermistor 28, the resistor 132, and the resistor 134. As described herein, the operation of the transitory 112 is controlled by the control signal “SAMPLE_COOL”, which can be implemented as a periodic signal, generated by the processing device. The frequency and duty cycle of the control signal “SAMPLE_COOL” can determine when switching circuit 36 outputs the voltage that relates to the resistance of the thermistor 28 at the output 148 (i.e., when the transistor 112 is turned “on”). For example, in exemplary embodiments, the control signal “SAMPLE_COOL” can be generated to turn “on” the transistor 112 when a resistance of the thermistor 28 corresponds to a temperature of the fluid within which the thermistor 28 is disposed such that the voltage output by the switching circuit 36 at the output 148 corresponds to a water temperature measured by the thermistor 28. The control signal “SAMPLE_COOL” can be a pulse width modulated signal that have a low duty cycle and a specified frequency. The low duty cycle advantageously allows the transistor to be turned on for a short period of time to allow for measuring the fluid temperature via the thermistor 28 without excessively heating the thermistor 28. In some embodiments, the duty cycle of the control signal “SAMPLE_COOL” can be approximately five (5) percent (e.g., the signal is high for five percent of the period).

The second water temperature stage 38 can include a non-inverting amplifier formed by an operational amplifier 152 and a negative feedback resistor 154. A positive terminal 156 of the operational amplifier 152 receives the output 148 of the switching circuit 36 as an input and an input to a negative terminal 158 of the operational amplifier 94 is determined by a voltage divider formed by resistors 160 and 162 and the negative feedback resistor 154. An output 164 of the operational amplifier 94 is operatively coupled to the processing device 14 via a “WATER_TEMP_2” node 166. The second water temperature stage 38 can operate to output a voltage to the processing device that corresponds to a temperature of the thermistor 28 based on the voltage received from the output 148 of the switching circuit 36.

The output stage 40 can include a comparator 168 having a positive terminal 170, a negative terminal 172, and an output 174. The positive terminal 170 and negative terminal 172 can have high input impedances (e.g., one mega ohm). As shown in FIG. 2, the positive terminal 170 of the comparator 168 can receive as an input, a voltage that is determined by an operation of the thermistor 28, the transistor 110, and the transistor 112 and the negative terminal 172 can receive, as an input, the output 80 from the switching circuit 32. The output 174 of the comparator 168 can be operatively coupled to a “COOL_PULSE” node 176 of the processing device 14.

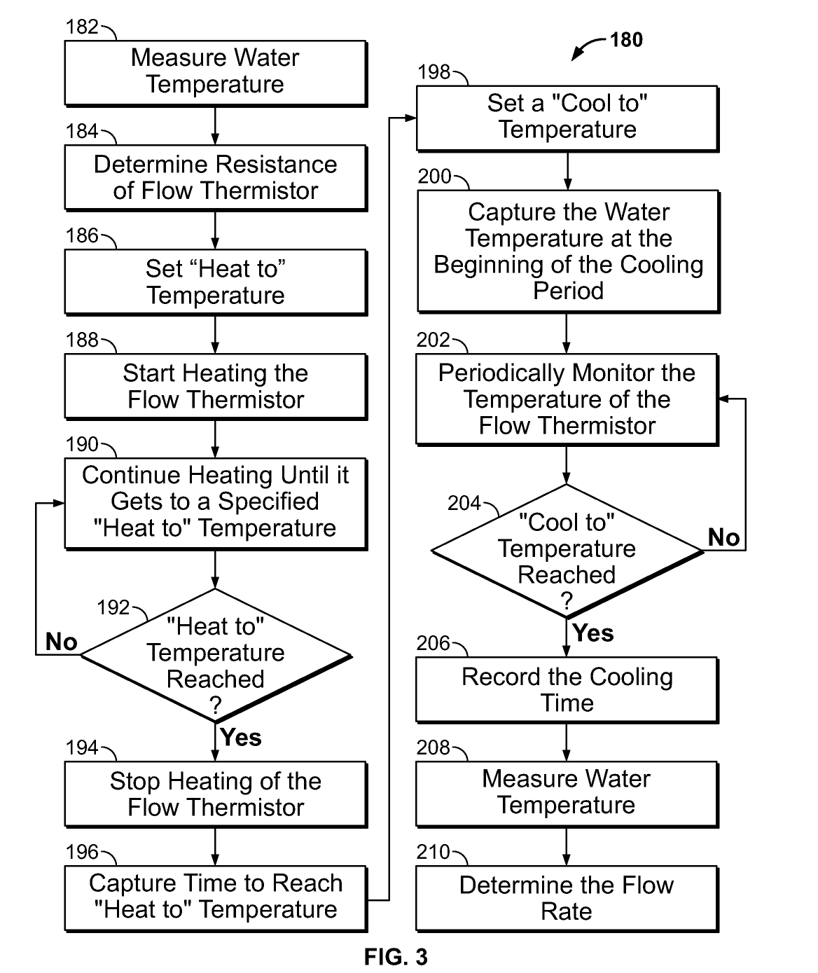

FIG. 3 is a flowchart of an exemplary process 180 implemented by exemplary embodiments of the flow monitoring systems described herein, for example, with respect to FIGS. 1A, 1B, and 2 (e.g., systems 10 and/or 10′). The processing device 14 executes the firmware to output a control signal to the “HEAT_TEMP” node to turn off the transistor 42 (e.g., to drive the gate of the transistor 42 low) and executes the firmware to output a control signal to the “COOL_TEMP” node to turn on the transistor 44 (e.g., to drive the gate of the transistor 44 high) and, at step 182, the firmware is executed by the processing device to measure the voltage at the output node “WATER_TEMP_1” of the operational amplifier 94, which can correspond to the water temperature sensed by the water thermistor (e.g., thermistor 26). Next, the processing device 14 executes the firmware to output the control signal “SAMPLE_COOL” to turn on the transistor 112 (e.g., to drive the transistor 112 high), and with the transistor 112 on, the processing device can execute the firmware to measure the voltage at the output node “WATER_TEMP_2” of the operational amplifier 152 at step 184 to determine a resistance of the unheated flow thermistor (e.g., thermistor 28), which should correspond to the water temperature. In exemplary embodiments, the processing device 14 can measure the voltage at the output of the comparator 152 immediately after the transistor 112 is turned on. This can reduce any heating effects of the flow thermistor due to the electrical current drawn through the transistor 112. Using this approach, the effect of heating the flow thermistor is negligible and the voltage at the WATER_TEMP_2 node is generally a good representation of the resistance of the unheated flow thermistor. The voltages measured at WATER_TEMP_1 and WATER_TEMP_2 can be used later on during the computation of the flow rate to correct for drift in the flow thermistor. For example, in some embodiments, the difference between the WATER_TEMP_1 and WATER_TEMP_2 voltages can be computed and processed to compensate for drift in the resistance of the thermistor 28.

At step 186, a “heat to” temperature threshold can be set by turning on 42 and turning off 44 in response to control signals output by the processing device 14 upon execution of the firmware. This results in the output of 78 of the switching circuit 32 providing a voltage at the positive terminal of the comparator 114 corresponding to a specified temperature above the fluid temperature within which the thermistor 26 is disposed. This voltage represents the “heat to” temperature and can be set based on the values of the resistors 52 and 54 as well as the resistance of the thermistor 26 and the voltage applied to the thermistor 26. In some embodiments, the voltage output by the output 78 can be set so that the “heat to” temperature is approximately 20 to approximately 70 degrees Celsius above the fluid temperature. In some embodiments, the voltage output by the output 78 can be set so that the “heat to” temperature is approximately 40 to approximately 50 degrees Celsius above the fluid temperature. In some embodiments, the “heat to” threshold can be set after the start of heating the flow thermistor 28 because it can take seconds for the flow thermistor 28 to achieve the “heat to” temperature.

At step 188, the processing device 14 can start heating the flow thermistor 28 by outputting a control signal in the form of a pulse to the “HEAT_PULSE” node, which is operatively connected to the gate of the transistor 110 to turn on the transistor 110 (e.g., drives the gate of the transistor 110 high for a specified period of time and then ceases to drive the gate of the transistor 110). In some embodiments, the transistor 112 can be turned on during heating of the thermistor 28 to assist in heating the thermistor to the “heat to” temperature, at which time, the transistor 112 is turned off, to stop all heating of the flow thermistor when the flow thermistor reaches the “heat to” temperature. In exemplary embodiments, the pulse can last for a programmed period of time. For example, the processing device can be programmed to output the pulse for a duration of about 1 millisecond to about 20 millisecond or from about 8 milliseconds to about 12 milliseconds. Rather than driving “HEAT_PULSE” node low after the specified time passes, the pin of processing device 14 (or microcontroller 30) connected to the “HEAT_PULSE” node essentially disconnects from the “HEAT_PULSE” node by transitioning to a high impedance pin, allowing the output of the comparator 114 to maintain the voltage at the gate of the transistor 110 at a high level at step 190 to allow the thermistor to continue heating until it gets to a specified “heat to” temperature. At this time, the voltage at the positive input of the comparator 114 is greater than the voltage at the negative input of the comparator 114 so that the output of the comparator 114 is high (e.g., 5 volts). Because the output of the comparator 114 is operatively coupled to the gate of the transistor 110, the output of the comparator 114 keeps the transistor 110 on after the pulse stops. As a result, the flow thermistor continues heating. The temperature of the flow thermistor continues to increase until the temperature of the flow thermistor reaches the “heat to” temperature at step 192, at which time the voltage at the negative input of the comparator 114 exceed the voltage at the positive input of the comparator 114 and the output of the comparator goes low (e.g., 0 volts). In response to the low voltage at the output of the comparator, the gate of the transistor 110 is driven to a low level at step 194 such that the comparator ceases to drive the gate of the transistor 110 high; thereby turning off the transistor 110, which stops the heating of the flow thermistor. When the 110 gate is driven low by the comparator 114, the processing device can capture the time it took to heat the flow thermistor to the “heat to” temperature threshold at step 196.

At step 198, the transistor 44 is turned on and transistor 42 is turned off, to present a “cool to” temperature threshold voltage being output from the output 80 of the switching circuit 32 to the negative terminal of the comparator 168. The “cool to” temperature threshold voltage can be set so that the “cool to” temperature is a specified temperature above the fluid temperature within which the thermistor 26 is disposed based on the values of the resistors 66, 68, and 70, as well as the resistance of the thermistor 26 and the voltage applied to the thermistor 26. approximately 1 to approximately 15 degrees Celsius above the fluid temperature In some embodiments, the voltage output by the output 80 can be set so that the “cool to” temperature is approximately 8 to approximately 12 degrees Celsius above the fluid temperature.

At step 200, the voltage at the “WATER_TEMP_1” node is measured to capture the water temperature at the beginning of the cooling period via the water thermistor 26. As the flow thermistor 28 cools, the temperature of the flow thermistor 28 is periodically monitored via the comparator 168 by briefly pulsing the gate of transistor 112, for example, every 830 us (i.e., using the “SAMPLE_COOL” control signal from the processing device) to implement a non-continuous periodic comparison of the temperature of the flow thermistor at step 202 to the “cool to” temperature until the “cool to” temperature is reached as determined by step 204. That is, the voltage associated with the temperature of the of the flow thermistor 28 and the voltage associated with the “cool to” temperature are periodically compared each time the “SAMPLE_COOL” control signal is high. As described herein, the “SAMPLE_COOL” control signal can have a low duty cycle (e.g., approximately one percent to approximately ten percent. This non-continuous measurement can maintain a low bias resistance (e.g., as determined by resistors 132 and 134) to minimize the effects of noise on the cooling time measurement and to prevent undesirable heating of the flow thermistor. For example, if the transistor 112 operated continuously during this measurement time, the flow thermistor can experience significant heating, which can affect the accuracy of the flow rate measurement. Thus, low-duty-cycle monitoring of thermistor cooling is used to prevent undesirable heating of the flow thermistor and to minimize the effects of noise on the measurements.

When the flow thermistor temperature reaches the “cool to” temperature threshold and the gate 112 is pulsed, the output of the comparator 168 transitions from high to low. That is, when the voltage associated with the temperature of the of the flow thermistor 28 is less than the voltage associated with the “cool to” temperature as measured when the gate 112 is pulsed, the output 174 of the comparator 168 transitions from high to low. This edge can be captured by the processing device 14 to record the cooling time at step 206. At step 208, the water temperature at the “WATER_TEMP_1” node is measured using the water thermistor. This water temperature measurement, combined with the measurement made at the beginning of the cooling period will correct the flow calculation in the event that the water temp changed during the cooling period. At step 210 the processing device can determine the flow rate. The temperature of the flow thermistor can continue to decrease towards the water temperature after the “cool to” temperature us reached and may ultimately reach the water temperature before the next time the flow rate is to be measured by embodiments of the system described herein (e.g., the system 10 or 10′).

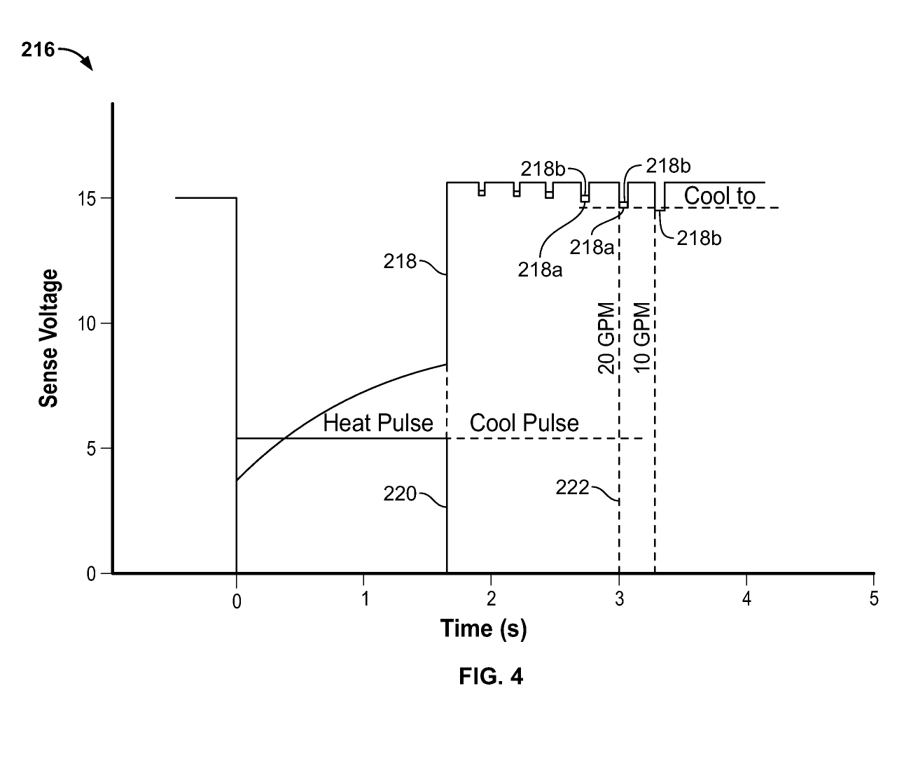

FIG. 4 is a graph 216 that shows a voltage curve 218 of the at the input of the positive terminal 170 of the comparator 168 over time relative to an operation of the transistor 112 as well as a curve 220 illustrating an input signal via the “HEAT_PULSE” node 126 and a curve 222 illustrating an output of the comparator 168 on the “COOL_PULSE” node 176. The y-axis of the graph corresponds to a voltage and the x-axis of the graph corresponds to time. At time equal to zero, the transistors 110 and 112 can be turned “on” for a period of time and a temperature of the thermistor 28 starts to increase as illustrated by the offset and trajectory of the voltage curve with respect to the y-axis at time equals zero. At time equal to approximately 1.75 seconds, the thermistor 28 reaches the “heat to” temperature, which corresponds to a voltage of eight volts in the present example and the gate of the transistor 110 is driven low by the output of the comparator 114 as shown by curve 220, turning the transistor 110 “off” and causing the “COOL_PULSE” to go high as shown by curve 222, at which time the thermistor is allowed to cool. The processing device 14 starts a timer when the “heat to” temperature is reached. At approximately time equal to 3.5 seconds, the temperature of the thermistor 28 reaches a “cool to” temperature, and the “COOL_PULSE” transitions from high to low as shown by the curve 222. In response the transition, the processing device stops the timer to determine how long it took the thermistor 28 to cool from the “heat to” temperature to the “cool to” temperature, which can be used by the processing device to determine the flow rate of water passed the thermistor 28. The longer it takes the thermistor to cool, the lower the flow rate. For example, two curves 218a and 218b are superimposed on each other during the cool down portion of the curve to illustrate how the temperature of the thermistor 28 decreases for a flow rate of twenty gallons per minute and ten gallons per minute, respectively.

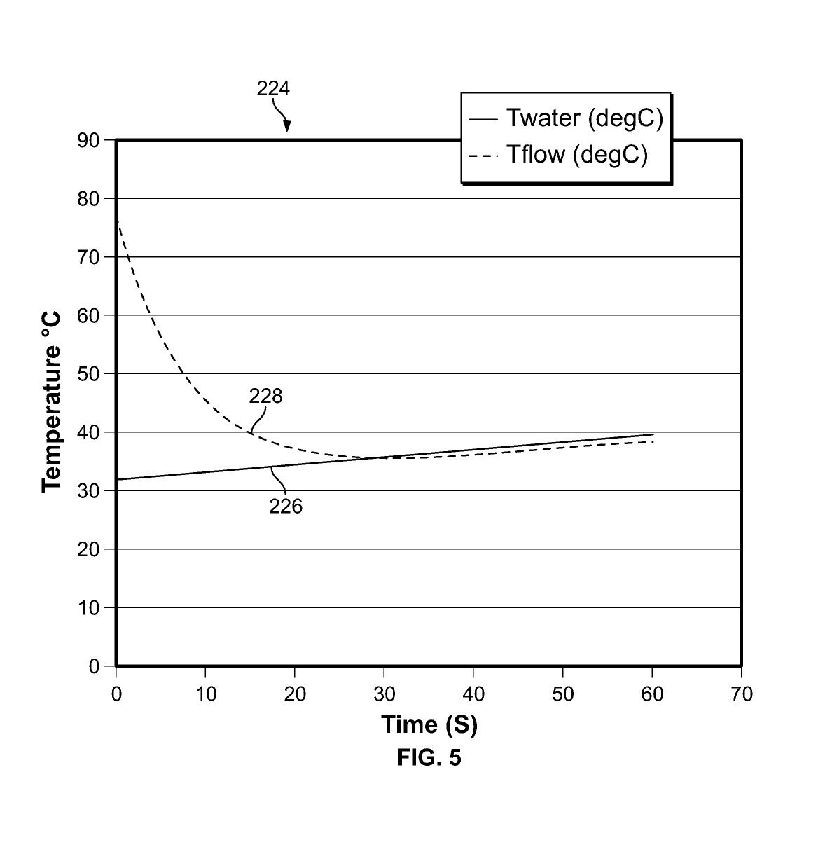

FIG. 5 is a graph 224 illustrating the effect of an increasing water temperature on flow measurements. The water temperature is shown as a curve 226 and the flow temperature is shown as a curve 228. If the water temperature changes during the cooling period, the water temperature can affect the flow rate measurements. For example, assuming water temperature is changing linearly with time, the cooling behavior of the thermistor 28 can be assumed to be described by a first-order differential equation. Thus, in some embodiments, to correct for changes in water temperature during the cooling period, the water temperature can be measured at the beginning and end of the cooling period (e.g., when the thermistor 28 reaches the “heat to” temperature and when the thermistor 28 reaches the “cool to” temperature).

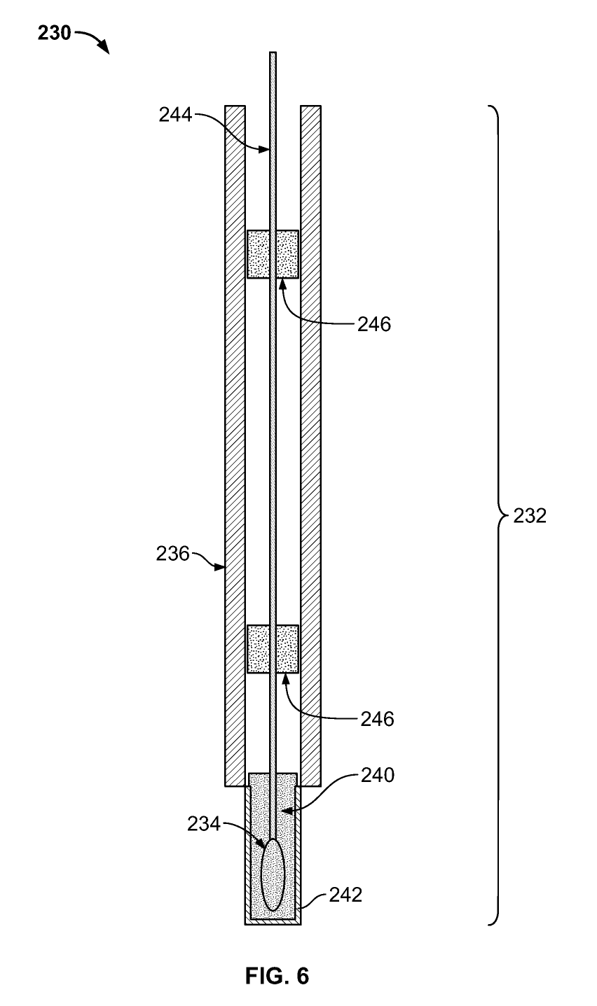

FIG. 6 shows an exemplary embodiment of a thermistor 230 that can be used to implement embodiments of the thermistors 26 and 28. The thermistor 230 can include a probe assembly 232 having a probe tip 234 and shaft 236. The probe tip 234 can be formed from a thermally conductive material, such as metal (e.g., stainless steel). A thermistor bead 238 and a thermally-conductive fluid 240 can be disposed with the probe tip 234. The thermistor bead 238 can be positioned centrally within the probe tip 234 and the thermally-conductive fluid 240 can flow around the thermistor bead 238 so that the thermally conductive fluid 240 is always in intimate contact with the thermistor bead 238 and an inner wall 242 of the probe tip 234. The shaft 236 can have a hollow body, and in some embodiments, can be tubular. In exemplary embodiments the shaft 236 can interface with the probe tip 234 to form a water tight seal between the probe tip 234 and the shaft 236. In exemplary embodiments, the shaft 236 can be formed of a thermally insulating material, such as a plastic material. Leads 244 of the thermistor 230 can extend from the thermistor bead 238 through the shaft 236 and can constrained centrally within the shaft 236 by spacers 246 so conduction of heat from the thermistor leads 80 to the surrounding environment e.g., (air, body, water) or vice versa can be minimized. The structure of the thermistor 230 can promote primary heat generation and heat loss within an immediate vicinity of the thermistor bead 238 and the probe tip 234 to improve an accuracy of the thermistor 230.

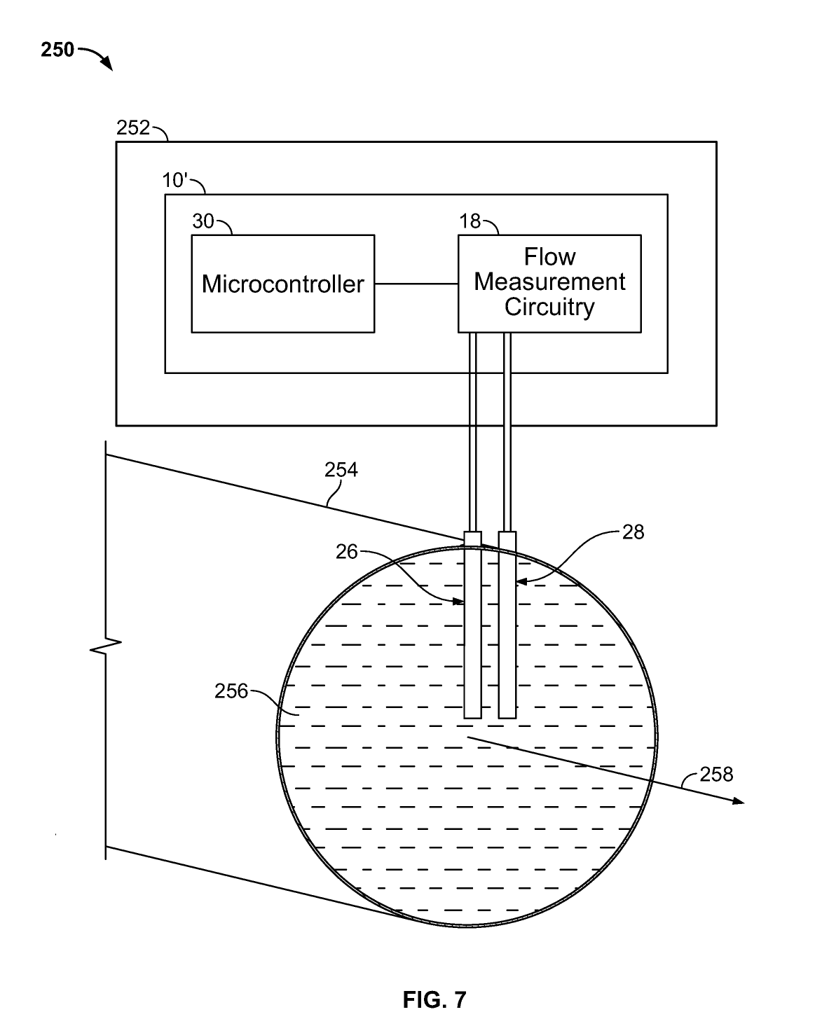

FIG. 7 shows an exemplary implementation of the system 10′ (or system 10) in a swimming pool/spa environment 250. As shown in FIG. 7, the system 10′ (or system 10) can be a subsystem of a system 252 that controls one or more swimming pool/spa functions or operation. For example, the system 252 can be, for example, a chlorinator, a water heater, and/or any other suitable swimming pool/spa system for which a flow rate of water can be utilized to carry one or more functions or operations. The thermistors 26 and 28 are disposed within a pipe 254 transporting water 256. The thermistors 26 and 28 are placed very close to each other so that the thermistors 26 and 28 experience similar transient and steady-state water temperatures. The leads 80 of the thermistors 26 and 28 are electrically coupled to the circuitry 18 and the circuitry 18 is electrically coupled to the microcontroller 30 (or processing device 14).

The water 256 can flow through the pipe 254 in a direction shown by arrow 258. The microcontroller 30 can control the circuitry 18 to periodically measure the water temperature and flow rate of the water 256 through the pipe 254. The flow rate of the water 256 through the pipe 254 can be measured by heating the thermistor 28 to a “heat to” temperature as described herein and then controlling the circuitry 18 to allow the thermistor 28 to “cool to” temperature as described herein. As the thermistor 28 cools to the “cool to” temperature, the microcontroller 30 can control the circuitry 18 to periodically sample a temperature of the thermistor 28 to determine when the thermistor 28 reaches the “cool to” temperature and can use the time it takes the thermistor 28 to cool to the “cool to” temperature and/or the temperatures of the thermistors 26 and/or 28 to determine the flow rate of the water 256 through the pipe 254. In exemplary embodiments, the thermistor 26 and circuitry 18 can be used to ensure that the “heat to” temperature of the thermistor 28 is approximately 50 degrees Celsius above the water temperature and the “cool to” temperature of the thermistor 28 is approximately 10 degrees Celsius above water temperature. This allows the heating and cooling behavior of the thermistor 28 to be substantially consistent over water temperature. In some embodiments, the system can adjust for changes in water temperature by measuring the water temperature at the beginning of the cool down period and at the end of the cool down period.

As described herein, exemplary embodiments of the present disclosure advantageously cycle or pulse a thermistor to heat the thermistor to reduce unnecessary dissipation of heat by the thermistor when the thermistors are not being used to measure a flow rate (e.g., wasted energy) compared to conventional thermally-dissipative flow sensing systems. By reducing unnecessary dissipation of heat, exemplary embodiments can eliminate and/or reduce “start-up” conditions having long settling times, which often exist in conventional thermally-dissipative flow sensors. Cycling or pulsing the thermistor can also advantageously permit the thermistors to withstand higher heating temperatures as compared to conventional thermally-dissipative flow sensing systems. By permitting thermistors to be heated to higher temperatures than thermistors in conventional thermally-dissipative flow sensors, exemplary embodiments can exhibit greater accuracy and/or signal-to-noise ratio. Cycling or pulsing the thermistor can also advantageously reduce thermal stress experienced by thermistors as compared to conventional thermally-dissipative flow sensing systems by cycling the heating of the flow thermistor. By reducing the thermal stress experienced by flow thermistor, the flow thermistor utilized by exemplary embodiments of the present disclosure can advantageously exhibit longer life expectancy than comparable thermistors utilized in conventional thermally-dissipative flow sensor systems.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step. Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other embodiments, functions and advantages are also within the scope of the invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

What is claimed is:

1. A system for measuring a flow rate of a fluid, the system comprising:
a fluid thermistor disposed in a fluid;
a flow thermistor disposed in the fluid;
flow measurement circuitry operatively coupled to the fluid thermistor and the flow thermistor; and
a processing device operatively coupled to the flow measurement circuitry, the processing device being programmed to control the flow measurement circuitry to periodically increase a temperature of the flow thermistor to a first temperature and allow the temperature of the flow thermistor to decrease to a fluid temperature,
wherein the processing device is programmed to determine a flow rate based on an amount of time that elapses between the flow thermistor having the first temperature and the flow thermistor having a second temperature that is set based on the fluid thermistor.

2. The system of claim 1, wherein the processing device is programmed to output a control signal to the flow measurement circuitry for a programmed period of time, the flow measurement circuitry increasing the temperature of the flow thermistor in response to the control signal, wherein the processing device ceases the control signal after the programmed period of time elapses.

3. The system of claim 2, wherein the flow measurement circuitry is configured to continue increasing the temperature of the flow thermistor after the programmed period of time elapses.

4. The system of claim 3, wherein the flow measurement circuitry is configured to continue increasing the temperature of the flow thermistor until the temperature of the flow thermistor reaches the first temperature.

5. The system of claim 1, wherein the flow measurement circuitry comprises a first switching circuit having first electronic switch operatively coupled to the processing device and the flow thermistor, wherein the processing device controls the first electronic switch to periodically increase the temperature of the flow thermistor.

6. The system of claim 5, wherein the first switching circuit further comprises a second electronic switch operatively coupled to the processing device and the flow thermistor, wherein the processing device controls the second electronic switch to periodically sample the temperature of the flow thermistor.

7. The system of claim 1, wherein the flow measurement circuitry comprises a second switching circuit having a first electronic switch operatively coupled to the processing device and the fluid thermistor, wherein the processing device controls the first electronic switch to output a first voltage from the second switching circuit that corresponding to the first temperature.

8. The system of claim 7, wherein the second switching circuit further comprises a second electronic switch operatively coupled to the processing device and the fluid thermistor, wherein the processing device controls the second electronic switch to output a second voltage corresponding to the second temperature.

9. The system of claim 1, wherein the first temperature is set based on the fluid thermistor and the flow measurement circuitry comprises a comparator configured to compare a voltage based on a resistance of the flow thermistor to a voltage based on a resistance of the fluid thermistor, wherein the flow measurement circuitry stops increasing the temperature of the flow thermistor when the voltage based on a resistance of the flow thermistor is greater than or equal to the voltage based on a resistance of the fluid thermistor.

10. The system of claim 1, wherein the flow measurement circuitry comprises a comparator configured to compare a voltage based on a resistance of the flow thermistor to a voltage based on a resistance of the fluid thermistor and to output a control signal when the voltage based on a resistance of the flow thermistor is less than or equal to the voltage based on a resistance of the fluid thermistor, the control signal indicating that the flow thermistor has reached the second temperature.

11. The system of claim 10, wherein the processing device is programmed to output a sampling signal to the flow measurement circuitry to facilitate periodic measurement of the voltage associated a resistance of the flow thermistor, the sampling signal comprising a pulse width modulated signal have a duty cycle of approximately five percent.

12. The system of claim 1, wherein at least one of the flow thermistor or the fluid thermistor comprises:
a shaft having a hollow body;
a probe tip disposed at a terminal end of the shaft;
a thermal bead disposed within the probe tip;
a lead extending through the hollow body from the thermal bead, the lead being disposed along a centerline of the hollow body; and
a compliant thermal grease between the thermal bead and the probe tip to provide a thermally conductive path between the probe tip and the thermal bead.

13. A method of measuring a flow rate of a fluid, the method comprising:
controlling a flow measurement circuit to increase a temperature of a flow thermistor in response to a first control signal, the flow thermistor being disposed in a fluid;
comparing a voltage based on a resistance of the flow thermistor to a voltage based on a resistance of a fluid thermistor to determine whether the flow thermistor is greater than or equal to a first temperature, the fluid thermistor being disposed in the fluid;
controlling the flow measurement circuit to stop increasing the temperature of the flow thermistor when the voltage based on a resistance of the flow thermistor is greater than or equal to the voltage based on a resistance of the fluid thermistor;
comparing a voltage based on a resistance of the flow thermistor to a voltage based on a resistance of the fluid thermistor to determine whether the flow thermistor is less than or equal to a second temperature;
controlling the flow measurement circuit to output a second control signal when the voltage based on a resistance of the flow thermistor is less than or equal to the voltage based on a resistance of the fluid thermistor to indicate that the flow thermistor reached the second temperature;
determining a flow rate of based on a time that elapses between the flow thermistor reaching the first and second temperatures; and
allowing the temperature of the flow thermistor to continue decreasing towards a fluid temperature.

14. The method of claim 13, wherein the first control signal is output by a processing device operatively coupled to the flow measurement circuitry and the first control signal is output for a programmed period of time after which the first control signal ceases to be output from the processing device.

15. The method of claim 14, further comprising continuing to increase the temperature of the flow thermistor after the first control signal ceases to be output by the processing device.

16. The method of claim 13, further comprising periodically sampling a first output voltage from the flow measurement circuitry by the processing device, the first output voltage corresponding to a temperature of the flow thermistor.

17. The method of claim 13, wherein the first output voltage corresponds to a comparison of a voltage associated with the flow thermistor and a reference voltage associated with a cool-to temperature for the fluid.

18. The method of claim 13, further comprising sampling a second output voltage from the flow measurement circuitry by the processing device to correct drift associated with the fluid thermistor.

19. The method of claim 13, wherein the first temperature is a first specified number of degrees above the fluid temperature and the second temperature is a second specified number of degrees above the fluid temperature, the first specified number of degrees being greater than the second specified number of degrees.

20. The method of claim 13, further comprising controlling a flow measurement circuit to increase a temperature of a flow thermistor in response to a first control signal again after allowing the temperature of the flow thermistor to decrease a fluid temperature.

21. The method of claim 13, further comprising:
measuring the fluid temperature before and after the cooling of the flow thermistor to facilitate compensation for a changing fluid temperature.

22. The method of claim 13, further comprising:
measuring a voltage associated with the flow thermistor before heating;
comparing the voltage to a voltage associated with the fluid thermistor; and
compensating for drift in the flow thermistor based on the comparison.

23. A thermally dissipative flow rate sensor comprising:
a first switching circuit operatively coupled to a flow thermistor, the first switching circuit being configured to switch between a thermistor heating mode to heat the flow thermistor and a thermistor cooling mode to cool the flow thermistor; and
a second switching circuit operatively coupled to a fluid thermistor, the second switching circuit being configured to switch between outputting a first output voltage from the second switching circuit corresponding to a first temperature to which the flow thermistor is to be heated and outputting a second output voltage from the second switching circuit corresponding to a second temperature to which the flow thermistor is to be cooled.

24. The thermally dissipative flow rate sensor of claim 23, wherein the first switching circuit comprises:
a first electronic switch operatively coupled to the flow thermistor, the first electronic switch being operable to heat the flow thermistor; and
a second electronic switch operatively coupled to the flow thermistor in parallel with the first electronic switch, the second electronic switch being operable to output a sample voltage corresponding to a temperature of the flow thermistor.

25. The thermally dissipative flow rate sensor of claim 24, wherein each of the first and second electronic switches have a conductive state and a non-conductive state,
the first electronic switch being operable to heat the flow thermistor when the first electronic switch is in the conductive state and ceases to heat the flow thermistor when the first electronic switch is in the non-conductive state, and
the second electronic switch being operable to output the sample voltage when the second electronic switch is in the conductive state and to cease outputting the sample voltage when the second electronic switch is in the non-conductive state.

26. The thermally dissipative flow rate sensor of claim 25, further comprising:
a comparator having a first input terminal that operatively coupled to the flow thermistor, a second input terminal that is operatively coupled to the fluid thermistor, and an output terminal that is operatively coupled to the first switch,
wherein the comparator receives a flow thermistor voltage associated with temperature of the flow thermistor at the first input terminal and the first output voltage from the second switching circuit at the second terminal, and outputs a control signal to the first electronic switch from the output terminal in response to a comparison of the flow thermistor voltage and the first output voltage.

27. The thermally dissipative flow rate sensor of claim 26, wherein the first electronic switch transitions from the conductive state to the non-conductive state in response to the control signal output by the comparator when the flow thermistor voltage associated with temperature of the flow thermistor is greater than the first output voltage.

28. The thermally dissipative flow rate sensor of claim 23, further comprising:
a comparator having a first input terminal that is operatively coupled to the flow thermistor, a second input terminal that is operatively coupled to the fluid thermistor, and an output terminal configured to output a control signal in response to a comparison of a flow thermistor voltage associated with temperature of the flow thermistor received by the first input terminal and the second output voltage from the second switching circuit received by the second terminal.

29. The thermally dissipative flow rate sensor of claim 28, wherein the control signal output by the comparator indicates that the flow thermistor has reached the second temperature when the flow thermistor voltage associated with temperature of the flow thermistor is less than the second output voltage.

30. The thermally dissipative flow rate sensor of claim 23, wherein the second switching circuit comprises:
a first electronic switch operatively coupled to the fluid thermistor, the first electronic switch being operable to output the first output voltage; and
a second electronic switch operatively coupled to the fluid thermistor in parallel with the first electronic switch, the second electronic switch being operable to output the second output voltage.

31. The thermally dissipative flow rate sensor of claim 30, wherein each of the first and second electronic switches have a conductive state and a non-conductive state,
the first electronic switch being operable to output the first output voltage from the second switching circuit when the first electronic switch is in the conductive state and to cease outputting the first output voltage from the second switching circuit when the first electronic switch is in the non-conductive state, and
the second electronic switch being operable to output the second output voltage from the second switching circuit when the second electronic switch is in the conductive state and to cease outputting the second output voltage from the second switching circuit when the second electronic switch is in the non-conductive state.
